(19) United States
(12) Patent Application Publication
(10) Pub. No.: US 2007/0061414 A1
(43) Pub. Date: Mar. 15, 2007

(54) ETHERNET INTERCONNECTION AND INTEROPERABILITY OF DISPARATE SEND AND RECEIVE DEVICES

(76) Inventor: Steve Bakke, Addison, TX (US)

Correspondence Address: H. Dale Langley, Jr.;The Law Office of H. Dale Langley, Jr., 610 West Lynn, Austin, TX, 78703, US

(21) Appl. No.: 11/458,779

(22) Filed: Jul. 20, 2006

Related U.S. Application Data
(60) Provisional application No. 60/701,278, filed on Jul. 21, 2005.

(51) Int. Cl. G06F 15/16

(52) U.S. Cl. 709/217

(57) ABSTRACT

An overall communications network, functionality, operability, and architecture includes a plurality of source devices and destination devices, each such devices having different and disparate communications capabilities, protocols, operabilities, and functionalities, to deliver information from each of the source device and receive the information by the destination device, through communications over an Ethernet network. The information delivered and received between respective devices is audio, video and control, or certain ones thereof or other information. The software and hardware of the architecture include a universal system that enables like source devices (audio, video, and control, etc.) to send information to any like destination device, applicable communicated information over the Ethernet network. For example, a video type destination device (e.g., a display) can receive video information from any video source device of the network and architecture, regardless of the type of the video information generated by the video delivery device, communicated over the network, and received by the recipient source device. Similarly, any audio type destination device (e.g., speaker) selectively can reproduce audio received over the network from any audio source device. Network protocols for communications over the network enable the desired communications between source device(s) and recipient/destination devices(s), and converters/adapters of or associated with each source and destination enable any appropriate data processing, formatting, and/or protocols to enable the communications via the network. Example source devices include Cable Boxes, Stereos, and PCs, among others. Example destination devices include LCD Displays, TVs and Speakers, among others. A single source device can provide information to multiple destination devices, including, for example, a display type destination device may receive and display information from multiple source devices. Additionally, set-up of the dissemination, direction, and receipt of information communicated can be controlled via the interconnected and interoperable devices and/or via standalone control programs or communications hardware of the network and/or devices of the network.

### BACKGROUND OF THE INVENTION

The present invention relates in general to interconnecting of devices and more particularly to the connection of audio, video and control information between different types of devices over a wireless and wired Ethernet network.

Traditionally devices are connected to other devices with separate forms of wiring and many different protocols for communications therebetween. For example, personal computer and other processing devices (PCs) are connected to monitors using a VGA or DVI protocols and cables, to keyboards using PS/2 or USB protocols and cables and to speaker using analog audio over audio cabling. Similarly TVs are connected to Cable Box, DVD players, Satellite receivers, etc using another set of protocols and cables: NTSC, S-Video, Component Video, DVI, HDMI, Stereo Audio, etc. Because of these cables types and varied protocols, communicatively connected devices typically must be physically located close to each other and therefore it is impractical or not possible to connect multiple ones of these and other communicative devices together. Similarly many of these devices cannot communicate because of differences between their respective protocols, cables, and other features inherent to or employed by the respective devices.

Therefore it is desirable to provide these interconnectability and interoperability, including intercommunications capability, among multiple types of and disparate devices, all over a standard, scalable and distributed medium: Ethernet or other common networked channels.

### SUMMARY OF INVENTION

An embodiment of the invention is a method to virtually connect various and disparate communications and information devices together via an Ethernet network. The respective devices include source devices, for dissemination of video, audio, control and other information, the respective devices also include destination devices for receiving and using such information. The Ethernet network may either be a wired Ethernet network, a wireless Ethernet network, combinations or other communications connections or networks. The number and types of the devices so communicably connected can be unlimited. The protocols for providing these communicative connections is universal, such that virtually any source device can connect and deliver information to substantially any destination device.

Another embodiment of the invention includes a fully distributed fault-tolerant system and method for the distribution and receipt by, between and among the various substantially unlimited number of communicably connected different and disparate devices.

Yet another embodiment of the invention includes hardware, software, or other components or combinations thereof, creating and enabling physical and communicative connections between and among the different and disparate devices. The Ethernet or other network or communicative channel(s) components or functionalities for enabling the communicative operations between and among the device(s), may be contained or enabled via the device(s), themselves, or within a standalone adapter.

Another embodiment of the invention includes controller for making or enabling these interconnections and intercommunicative operabilities. The controller can be included or inherent in the respective device(s), themselves, or the controller can be any software, hardware, combination or other controller, for example, control provided as running on standard PCs, servers, other equipment, software and the like.

Yet another embodiment of the invention includes a loss-less video compressor to reduce the bandwidth for the communications respective source and destination devices, for example, between video dissemination and video display devices or the like.

Another embodiment of the invention includes a single plug-in PC graphics card. The graphics card includes an interface to a PC bus and a single Ethernet interface for connecting to the network. The graphics card, for example, disseminates, communicates, and provides information to multiple displays, for example, up to hundreds or thousands of displays, either concurrently or in substantially concurrent times.

### BRIEF DESCRIPTION OF THE DRAWINGS

FIG. 1 is an example of a system in a home environment, according to embodiments of the present invention;

FIG. 2 is an example of a system in a business environment, according to embodiments of the present invention;

FIG. 3 is an example of a system in a commercial environment, according to embodiments of the present invention;

FIG. 4 is an example of adapters employable for conventional devices to allow communicative interoperability between and among devices, according to embodiments of the present invention;

FIG. 5 is an example of a display adapter device, for use as the adapter in the examples of FIG. 4 in sending and receiving video information between and among devices, according to embodiments of the present invention;

FIG. 6 is an example of an ASIC/FPGA for inclusion within or connected to a display adapter device, for use as the adapter in the examples of FIG. 4 in sending and receiving video information between and among devices, according to embodiments of the present invention;

FIG. 7 is an example of a server of a network in accordance with the systems of the foregoing Figures, for sending and delivery of an information, such as a information data stream for video, audio, or the like, to multiple destinations, including multiple types of different and disparate recipient devices and/or including multiple types of different and disparate sending devices, according to embodiments of the present invention;

FIG. 8 is an example of a video compressor for the systems and methods of the foregoing examples in the other Figures, according to embodiments of the present invention;

FIG. 9 is a method of operations of command protocols between devices, adapters, and interconnected elements, according to embodiments of the present invention;

FIG. 10 is a method of operations of command protocols between a controlling server and devices, adapters and other interconnected elements, according to embodiments of the present invention; and

FIG. 11 is an Ethernet PC Graphics card, such as can be employed in the foregoing systems and methods of the Figures and otherwise, according to embodiments of the present invention.

### DETAILED DESCRIPTION OF THE INVENTION

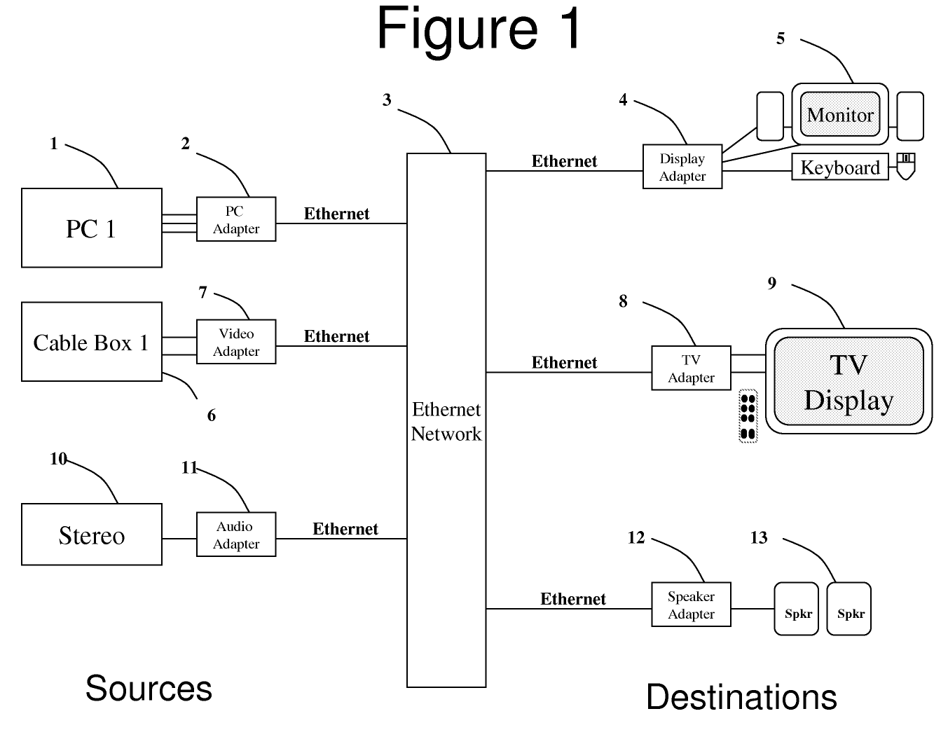

Referring to FIG. 1, an example set of source devices (PC 1, Cable Box 6, and Stereo 10) and destination devices (Monitor/Keyboard 5, TV Display 9 and Speakers 13) are communicably interconnected over and through an Ethernet Network 3. These source and destination devices are, for example, found in a home environment. The PC 1 and the Cable Box 6 source devices deliver video, audio and control to the either the Monitor/Keyboard 5 or TV Display 9 destination devices, in the example. The Stereo 10 and PC 1 source devices deliver audio information to the Speaker 13. All source and destination devices are communicatively connected to the Ethernet Network 3 via adapters: PC Adapter 2, Video Adapter 7, Audio Adapter 11, Display Adapter 4, TV Adapter 8 and Speaker Adapter 12. These adapters convert the video, audio and control information into/from Ethernet Packets, communicated over the network via standard or proprietary protocols, formats and the like. This adapter, and its functionalities, can be embedded into any respective device directly or otherwise associated with or connected to the respective device.

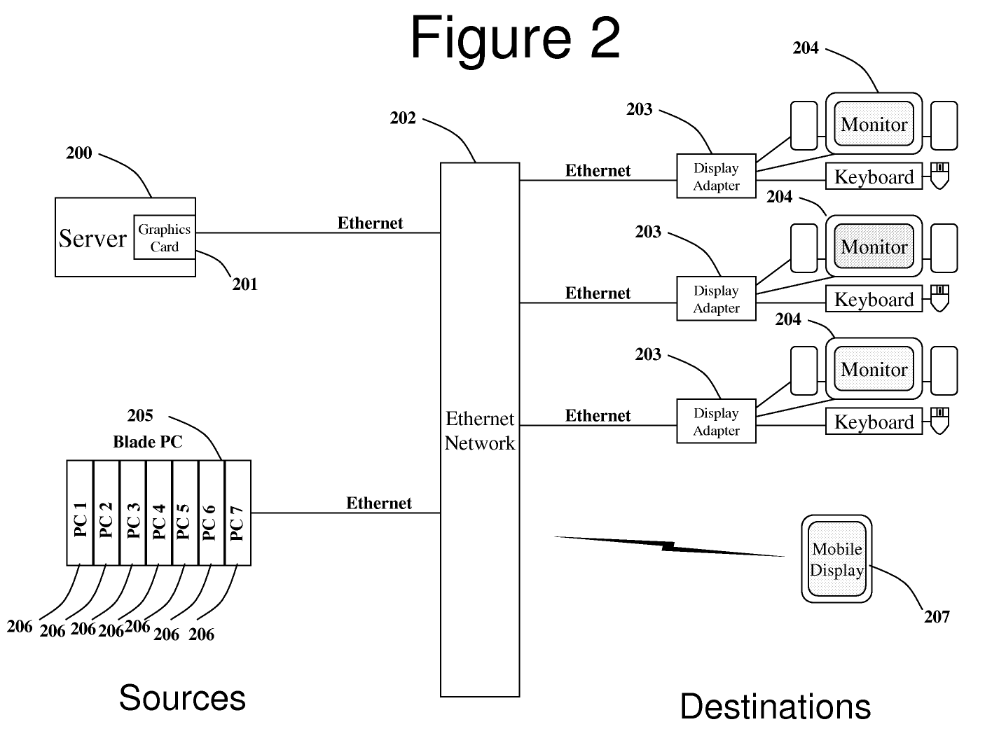

Referring to FIG. 2, an example set of source devices (Server 200, Blade PC 205) and destination devices (Monitor/Keyboard 204 and Mobile Display 207) present in an office environment, are interconnected and interoperable via the Ethernet network. The Server 200 device, in the example, includes a Multi-user Graphics Card 201 that provides distribution and dissemination of graphics data and other information to multiple different and disparate recipient devices and users simultaneously. The PC Blade 205 server includes multiple single user PC 206s, each on a card with a built-in adapter. The destination devices, or certain ones of them, include Monitor/Keyboard 204 and wirelessly connected Mobile Display 207. The Mobile Display 207 includes, for example, a standard LCD panel, touch screen, an wireless Ethernet interface, batteries, and/or other components or functionalities.

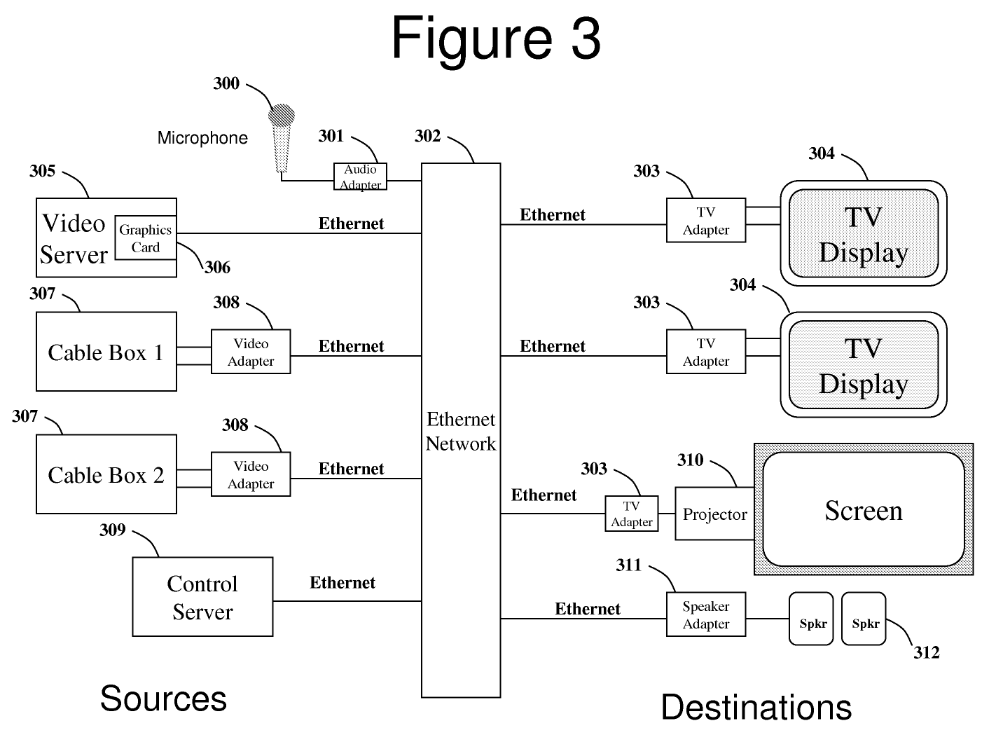

Referring to FIG. 3, an example set of source devices (Microphone 300, Video Server 305, Cable Box's 307) and destination devices (TV Display 304s, Projector 310 and Speakers 312), present in a commercial retail environment, are interconnected and interoperable over and through the Ethernet network. Video Server 305 includes a Graphics Card 306 that is capable of sending unique video feeds to multiple destinations, over the network. Control Server 309 controls set-up and tear-down of communicative connections and information communication between and among the various and respective source devices and destination devices.

Referring to FIGS. 1, 2 and 3, in conjunction, all respective source devices universally send information to any respective like or designated destination device(s) (e.g., video source to video destination, audio source to audio destination, etc.). Source devices can, in certain embodiments, send multiple different types of information, e.g., video and audio, or others, and combinations. The respective source and destination devices each convert the source output (e.g., sound, video, etc., as applicable) to Ethernet packets, protocols, formats, or other network or proprietary communications vehicles. Intercommunicated information of the Ethernet network is, for example, sent at the highest level of the relevant communications formats and protocols, so there is no loss of information between sender and recipient. Compression may be employed in communications on the network to limit bandwidth for all or certain communications, but information out, as played, displayed or otherwise output by the source device for user perception or use, is a bit for bit copy of information from the source device, whatever form that information may be (e.g., analog, digital, etc.) from the source device, and as converted to digital for the network communication to source device. This conversion of information to Ethernet packets, or other network communications form(s), is effected within the source and destination device or in an external adapter(s). In any case, the same or similar types of hardware, software, and/or other functional elements are used to make the various data conversions.

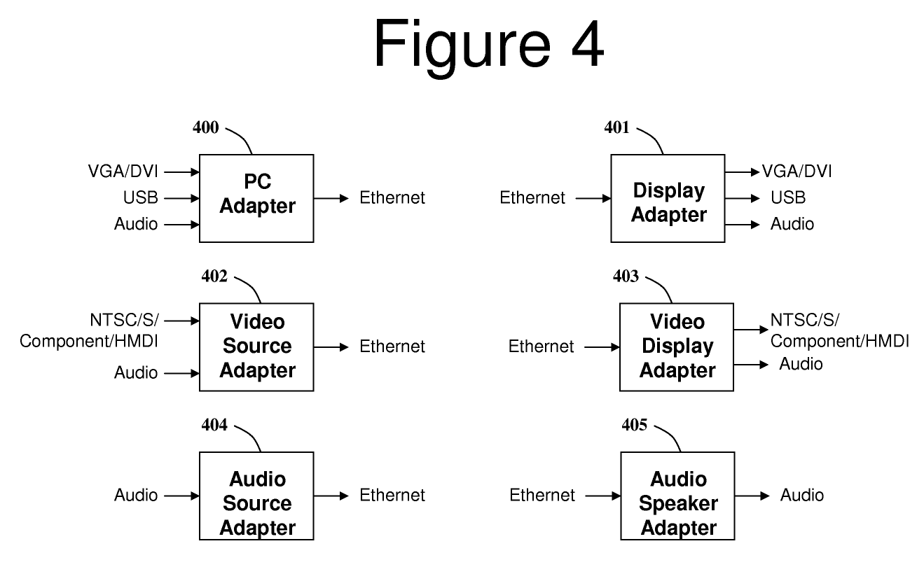

Referring to FIG. 4, adapters, connected to the source and destination devices, convert various forms of information into or from Ethernet packets or other network communications form(s). For example, PC Adapter 400 converts Video (VGA/DVI), Audio and USB into Ethernet packets for communication over the network. Video Source Adapter 402 converts various forms of video (NTSC, S, Component, HDMI) and Audio into Ethernet packets for network communication. Audio Source Adapter 404 converts only audio into Ethernet packets for network communications. Display Adapter 401 converts Ethernet packets into Video (VGA/DVI), Audio and USB. Video Display Adapter 403 converts Ethernet packets into various forms of video (NTSC, S, Component, HDMI) and Audio. Audio Speaker Adapter 405 converts Ethernet packets into only audio. Of course, other network protocols or data forms and formats, if applicable for the particular network, would be appropriate for communications over the network, as those skilled in the art will know and appreciate, and all such possibilities are included for purposes of the description herein.

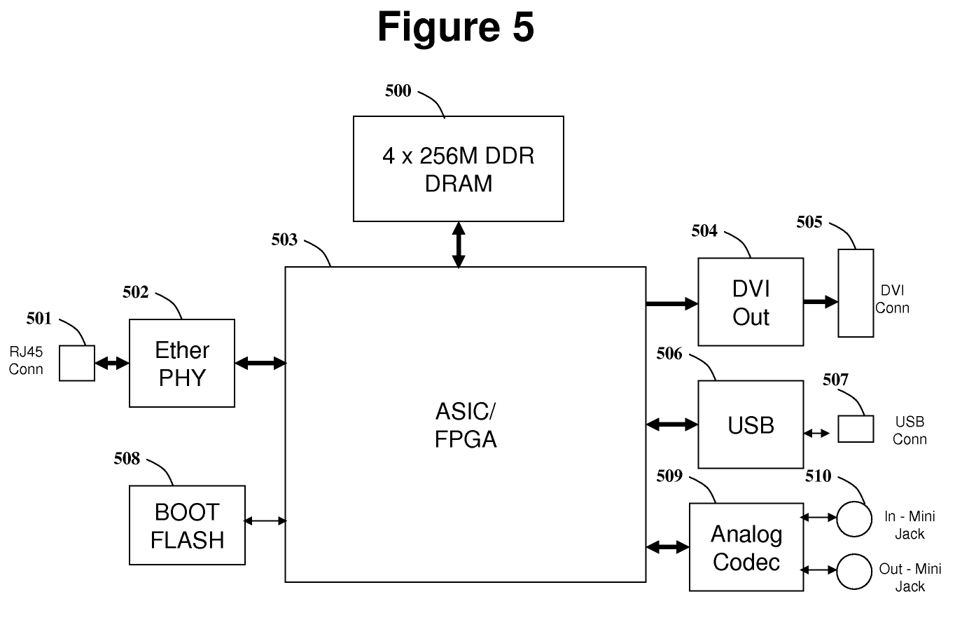

Referring to FIG. 5, a Display Adapter, such as for use as an adapter in the systems and methods otherwise discussed herein, includes an ASIC/FPGA 503. Components of the ASIC/FPGA 503 include a Boot Flash 508 that contains the program and logic code for the ASIC/FPGA 503. DRAM 500 of the ASIC/FPA 503 contains the framebuffers, Ethernet (or other network data) packets and other needed memory. Ethernet (or other data) packets arrive through RJ45 connector 501 of the ASIC/FPGA 503, and are then converter from analog to digital in the Ethernet PHY 502 and then flow into the other components of the ASIC/FPGA 503. Video data is output by and from ASIC/FPGA 503 into DVI Out IC 504 and through the DVI Connector 505. Similarly, USB information is output by and from ASIC/FPGA 503 to the USB PHY IC and through connector 507. Audio information is output by and from ASIC/FPGA 503 as converted into analog by Analog Codec IC 509 and delivered on to the audio connectors 510.

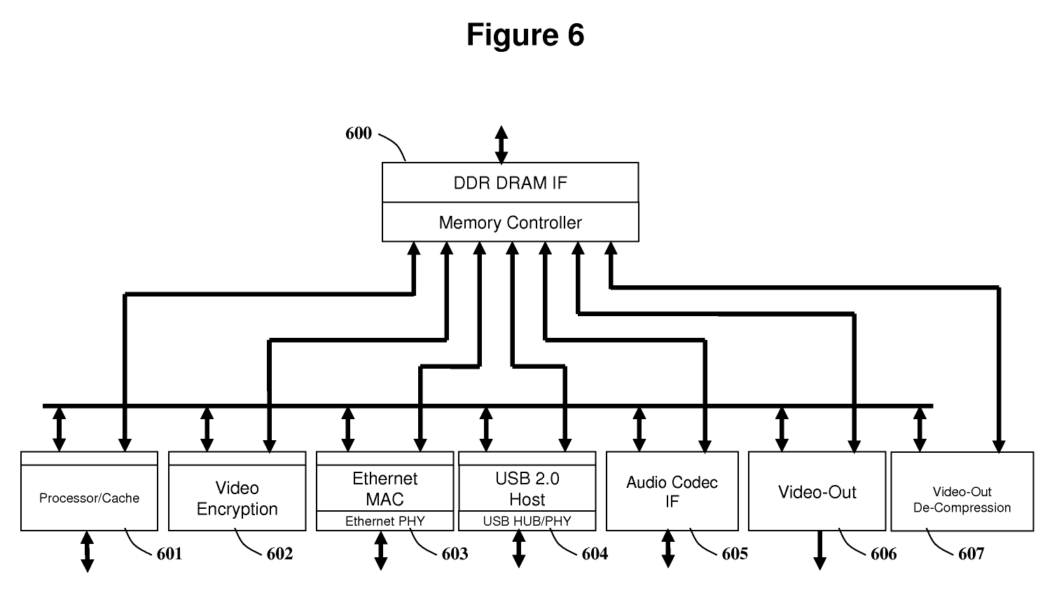

Referring to FIG. 6, the DRAM Controller 600 of the ASIC/FPGA 503 is communicably interconnected with most other blocks/components, and these other blocks/components read/write information into/from memory through the DRAM Controller 600. Processor/Cache 601 is the controller for the ASIC/FPGA 503. Video Encryptor 602 encrypts the Ethernet (or other data) packets where, if and as needed or desired in the application. Ethernet MAC 603 interfaces and connects between the external Ethernet PHY and DRAM Controller 600. USB Host 604 interfaces and connects between the external USB PHY and DRAM Controller 600. Audio Codec 605, similarly, interfaces and connects between the external audio codec and the DRAM Controller 600. Video-Out 606 interfaces and connects between framebuffer in DRAM Controller 600 and the external DVI Interface. Video-out De-compressor 607 reads video packets (or other network communicable video data) from DRAM Controller 600 and updates the framebuffer.

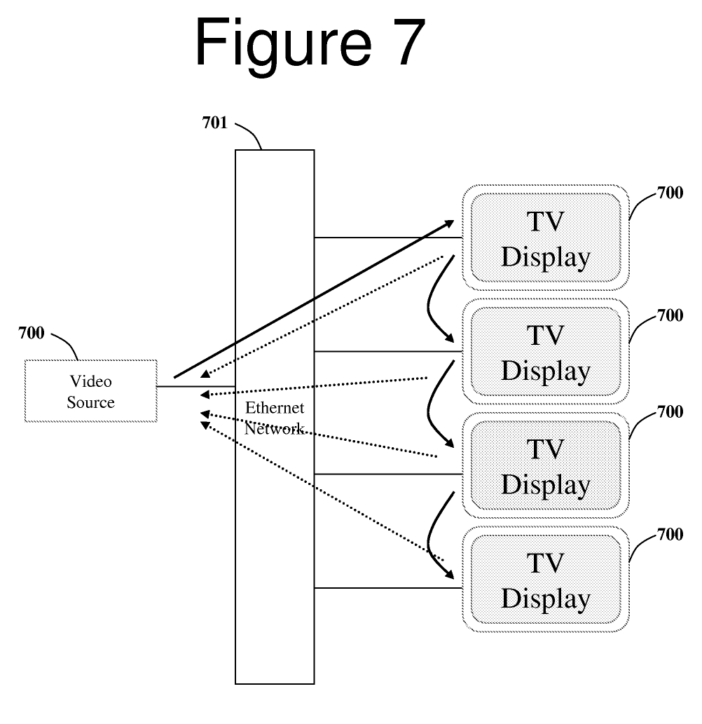

Referring to FIG. 7, systems and methods described herein enable sending a packet (or other data) stream to multiple destinations without using multi-cast. Video Source 700 sends a stream of video data for receipt 4 TV Display 702. A single stream is sent from Video Source 700 to TV Display 702, for example. TV Display 702 then uses the received stream and can further also relay the stream to TV Display 703. Added displays, such as TV Display 704, can be relayed the stream from TV Display 703, and on and on to further and other displays and devices in serial fashion. Via such relaying from display to display (or device to device, as the case may be), all four TV Displays, in the example (or others, if more or added or different devices, as well) receive the same video stream. As new destinations are desired, the last current destination in the list is directed to relay to the newly added destination. All TV Displays report back the status of their respective received streams to Video Source 700. If a destination “N” reports back that it is not receiving the stream, Video Source 700 will remove the “N−1” (i.e., immediately preceding relayer) destination from the list and inform “N−2” (i.e., the second preceding relayer) destination to relay to destination “N”. In this manner, the list and complete relay to all destinations is fault-tolerant.

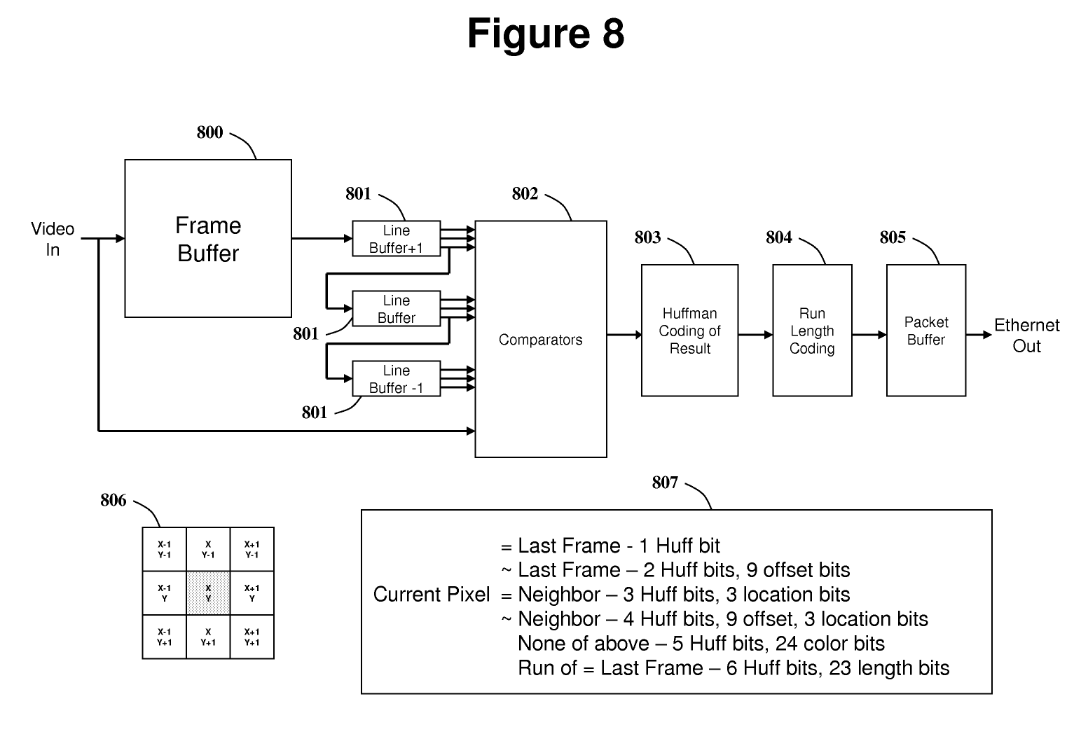

Referring to FIG. 8, a Video Compressor receives digital video data and writes the data into Frame Buffer 800. Substantially simultaneously, the Frame Buffer 800 is read and 3 lines of video information are written in the three Line Buffers 801. The three Line Buffers 801 contain: the previous line, the current line and the next line. The current input video pixel is compared to the same video pixel in the framebuffer and also the nearest neighbor pixels in Comparator 802. Comparator 802 detects and detemines the relationship of the current pixel and the neighbor pixel it is compared with. The output of Comparator 802 is eighteen (18) signals, in the example. Nine (9) signals define whether or not the current video input pixel is a direct match for the current framebuffer pixel and/or it's eight neighbors, and nine (9) signals define whether or not the current video input pixel is close (within 3 RGB values) to the current framebuffer pixel or it's eight neighbors. Huffman Coder 803 takes the result of comparison and Huffman Coder 803 codes the smallest representation of the input pixel based on the relationship to its neighbors. Coding Descriptor 807 describes the coding for each of the comparison results. Run-length Coder 804 further reduces the number of bits by run length encoding bits that are the same as the last frame. Then, the results from the Huffman Coder 803 and the Run-length Coder 804 are written into a Packet Buffer Block 805 and then sent out over the Ethernet (or other network). Video decompression at a Video Decompressor (similar to the Video Compressor) of the recipient/designation works in reverse direction/sequence to decode.

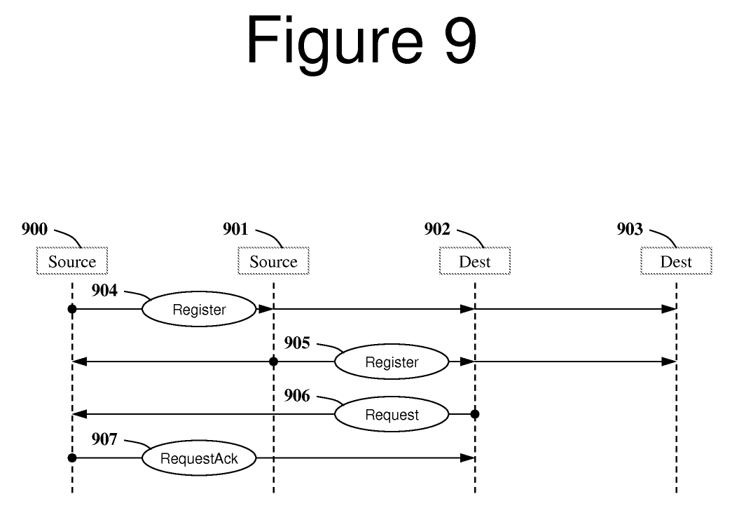

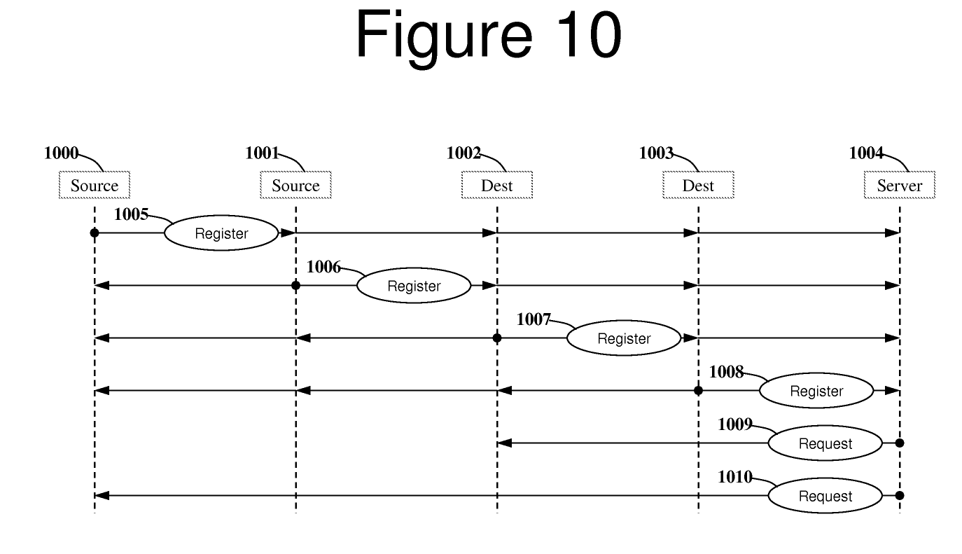

Referring FIGS. 9 and 10, in conjunction, a command protocol communicates and flows information between and among Devices and between Devices and Servers via the network. The command protocol determines respective device capabilities and sets-up/removes information transfers between and among devices. A controller, such as a software control program, hardware controller, or other element, on the respective devices, themselves, or on the Server, or other elements or combinations, generates, controls and performs this protocol. The controller can include a user interface, whereby a user can determine whether, if and when a respective device should communicate with another respective device.

The list and description of an example of the command protocol follows:

| Command | Direction | Description |
|---|---|---|
| Request | From | Device requesting a connection |
| RequestAck | To | Response to Invite |
| Query | To | Server requesting the device |
| | | configuration |
| QueryAck | From | Response to Query |
| Request | To | Server telling device to send/receive |
| | | information |
| RequestAck | From | Response to Request |
| Relay | To | Device should start relay a stream |
| RelayAck | From | Response to Relay |
| Register | From | Device has powered up |
| RegisterAck | To | Response to Register |
| RecPacketInfo | From | Statistics about data flows |
| Ping | Both | Test |
| PingAck | Both | Response to Ping |
| StatReq | To | Request Stats |
| StatReqAck | From | Response to Stats |
| UnknownCmd | Both | Received an unknown command |

In the protocol, the Request and RequestAck commands effect request to a connection or data flow between devices. A device may request a connection from another device or receive a Request command from a Server, informing it to make the connection. The Query command is 10 sent by a Server requesting the capabilities of a device. Capabilities are the type of information the device provides/uses: audio, video, control (RS-232, PS/2 Keyboard/Mouse, USB). Also exact data rates, screen sizes and number of windows are provided. The Relay command tells a device to use but also relay a given information/data flow or at the device to another device (as was illustrated in and described with respect to FIG. 7). The Register command is broadcast or sent directly to a server to inform that the respective device has powered up and is available. The Register command includes data indicative or identifying of a respective device's type and capabilities. The RecPacketInfo command is periodically sent by a respective device to inform another device about the packet loss, arrival times, etc of the incoming information/data communications and flows. The Ping by a respective device tests for the health and availability of other devices. The StatReq requests the overall status of a respective device. UnknownCmd command is sent any time a command is received that cannot be interpreted.

Referring to FIG. 9, an example is of a device wishing to communicate with another device where no Server is involved. The network, in the example, is made up of communicatively interconnected Source 900, Source 901, Destination 902 and Destination 903 devices. When Source 900 and Source 901 power up, they each broadcast Register 904 and Register 905 commands, respectively. Destination 902 and Destination 903, respectively, receive these commands and keep the content. Whenever Destination 902 desires to communicate with another device, the Destination 902 performs a lookup from the list of Register commands it has received, and picks an applicable Source 900. Destination 902 then sends a Request 906 command to Source 900. Source 900 receives this command and responds with a RegisterAck 907. Thereafter, Now Source 900 is enabled and connected to send information to Destination 902.

Referring to FIG. 10, another example is of a device wishing to communicate with another device where a Server is present and involved on the network. The Server in the example controls connections between respective network interconnected and intercommunicative devices. As respective devices power-up, they each broadcast register commands: Register 1005, Register 1006, Register 1007 and Register 1008. Server 1004 receives and discerns the respective Register commands (and is the only component of the network with interested in the Register commands in the example embodiment), and the Server saves the content of the Register commands. Server 1004, next and for example, determines that Source 1000 should communicatively connect to Destination 1002. Server 1004 sends Request 1009 to Destination 1002 and Request 1010 to Destination 1002. Now Source 1000 is enabled and connected to send information to Destination 1002.

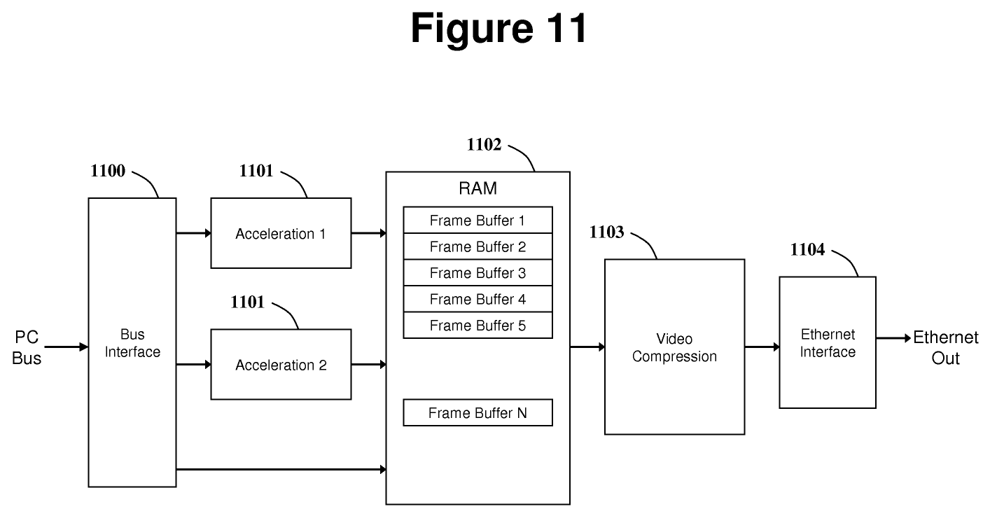

Referring to FIG. 11, a Multi-port Ethernet PC Graphics card allows for intercommunications and interoperability over the network through a single Ethernet (or other applicable network) interface to communicate with multiple devices or displays, such as hundreds or thousands or more displays can be driven via the card and network communications. Commands and data arrive over PC Interface 1100. The PC Interface is generally a processor bus or PCI/PCI Express. Accelerators 1101 may be included to off-load the processor from video tasks. Accelerators 1101 can include, for example, 2D Graphics, 3D Graphics and MPEG decode. The processor of the card, or the Accelerator 1101, if applicable, writes framebuffer information into the RAM 1102. The RAM 1102 contains framebuffers for all the relevant displays for communications over the network. Video Compressor 1103 compresses the framebuffers and creates Ethernet packets (or other network communications data formats). Ethernet Output 1104 sends the Ethernet packets (or other data) out over the Ethernet Interface through the network to the relevant recipient/destination devices.

What is claimed is:

1. A network including a communicatively connected source device and a communicatively connected destination device for network communications therebetween, comprising:
a first adapter for communicatively connecting the source device to the destination device over the network.

2. The network of claim 1, further comprising:
a second adapter for communicatively connecting the destination device to the source device over the network.

3. The network of claim 2, wherein the network is an Ethernet network, and the network universally connects the source device to the destination device, via the first adapter, such that video, audio and/or control information is communicable over the network from the source device to the destination device.

4. The network of claim 3, wherein the network universally connects the destination device to the source device, via the second adapter, such that video, audio and/or control information is communicable over the network for receipt by the destination device from the source device.

5. A network including a source device and more than one destination device, comprising:
a first adapter for communicatively connecting the source device to the more than one destination device over the network.

6. A PC Graphics card, comprising:
a network interface communicatively connectable to a plurality of displays.

7. The PC Graphics card of claim 6, further comprising:
a network connected to the network interface, wherein the network enables communicative connectability.

8. The PC Graphics card of claim 7, wherein the network is an Ethernet network, selected from the group consisting of: wired, wireless, optical, and combinations.

9. A network for communications by and among a plurality of source devices and a plurality of designation devices, comprising:
A controller connected to the network for establishing desired communications between ones of the plurality of source devices and ones of the plurality of destination devices.

10. A method of communications over a network, comprising the steps of:
sending information by a source device of the network; and
receiving the information by selective ones of a plurality of destination devices of the network.

11. A method of reducing bandwidth utilized in communications over a network, comprising the steps of:
loss-less compressing of communicated data of the network.
